(19) United States
(12) Patent Application Publication
(10) Pub. No.: US 2012/0056973 A1
(43) Pub. Date: Mar. 8, 2012

(54) HOUSING FOR CONFERENCE DEVICE AND CONFERENCE DEVICE HAVING SUCH HOUSING

(76) Inventor: Ryota YANO, Kanagawa (JP)

(21) Appl. No.: 13/222,312

(22) Filed: Aug. 31, 2011

(30) Foreign Application Priority Data
Sep. 2, 2010 (JP) 2010-196652

(51) Int. Cl. H04N 7/15; G03B 21/14

(52) U.S. Cl. 348/14.08; 353/119; 348/E07.083

(57) ABSTRACT

A housing for a conference device, and the conference device including such housing, are disclosed. The housing includes a top surface, a front side surface, and a back side surface provided opposite of the front side surface. The cross-sectional width of the housing is generally made smaller from the front side surface to the back side surface so as to make the top surface to have a trapezoid like shape or a triangle like shape.

### CROSS-REFERENCE TO RELATED APPLICATIONS

This patent application is based on and claims priority under 35 U.S.C. §119 to Japanese Patent Application No. 2010-196652, filed on Sep. 2, 2010, in the Japan Patent Office, the entire disclosure of which is hereby incorporated herein by reference.

### FIELD OF THE INVENTION

The present invention generally relates to a housing used for a conference device that communicates with a counterpart conference device through a network, and the conference device including such housing.

### BACKGROUND

The recent conference devices, which allow two-way communication between or among a plurality of conference devices through a network, are mainly classified into conference application software that cause general-purpose computers to function as the conference devices, and communication terminals specially designed to function as the conference devices. The communication terminals are often used when there are more than one participant involved in communication at one site. Some communication terminals are portable as described in Japanese Patent Application Publication Nos. H10-285569 and 2008-154055.

The portable-type communication terminal may be used together with a projector to project an image processed by the communication terminal onto a screen. In such case, to prevent the communication terminal from blocking the image to be projected onto the screen, the communication terminal should be placed outside of the angel of view of the projector. However, depending on various conditions such as a room where meeting takes place, a number of meeting participants, and capability of the projector, the communication terminal may only be placed between the projector and the screen. In case the communication terminal is placed between the projector and the screen, if the communication terminal has a housing described in Japanese Patent Application Publication No. H10-285569 or 2008-154055, the communication terminal is most likely to block the projection lights projected from the projector toward the screen.

In view of the above, there is a need for a housing used for the conference device, and the conference device having such housing, which does not block the projection lights projected from the projector toward the screen even when the conference device is placed between the projector and the screen.

### SUMMARY

Example embodiments of the present invention include a housing for a conference device to receive image data from a network and to output processed image data to an image output device to cause the image output device to project an image of the processed image data to an object. The housing includes a top surface, a front side surface, and a back side surface provided opposite of the front side surface. The cross-sectional width of the housing is generally made smaller from the front side surface to the back side surface so as to make the top surface to have a trapezoid like shape or a triangle like shape.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a perspective view illustrating the outer appearance of a conference device with a camera section being in the stand-up position, according to an example embodiment of the present invention;

FIG. 2 is a top plan view illustrating a housing of the conference device of FIG. 1;

FIG. 3 is a side view illustrating the housing of the conference device of FIG. 1;

FIG. 4 is a perspective view illustrating the outer appearance of the conference device of FIG. 1 with the camera section being in the folded position.

FIG. 5 is a schematic block diagram illustrating the hardware structure of the conference device of FIG. 1;

FIG. 6 is an illustration for explaining the arrangement of the conference device of FIG. 1 and a projector, according to an example embodiment of the present invention;

FIG. 7 is an illustration of a system configuration including a plurality of the conference devices of FIG. 1, according to an example embodiment of the present invention;

FIG. 8 is a perspective view illustrating the outer appearance of a conference device with a camera section being in the stand-up position, according to an example embodiment of the present invention;

FIG. 9 is a top plan view illustrating a housing of the conference device of FIG. 8;

FIG. 10 is a side view illustrating the housing of the conference device of FIG. 8;

FIG. 11 is a perspective view illustrating the outer appearance of the conference device of FIG. 8 with the camera section being in the folded position;

FIG. 12 is a perspective view illustrating the outer appearance of the conference device with the camera section being in the stand-up position, according to an example embodiment of the present invention;

FIG. 13 is a top plan view illustrating a housing of the conference device of FIG. 12;

FIG. 14 is a side view illustrating the housing of the conference device of FIG. 12;

FIG. 15 is a perspective view illustrating the outer appearance of the conference device of FIG. 12 with the camera section being in the folded position; and

FIG. 16 is an illustration for explaining the arrangement of the conference device of FIG. 12 and a projector, according to an example embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

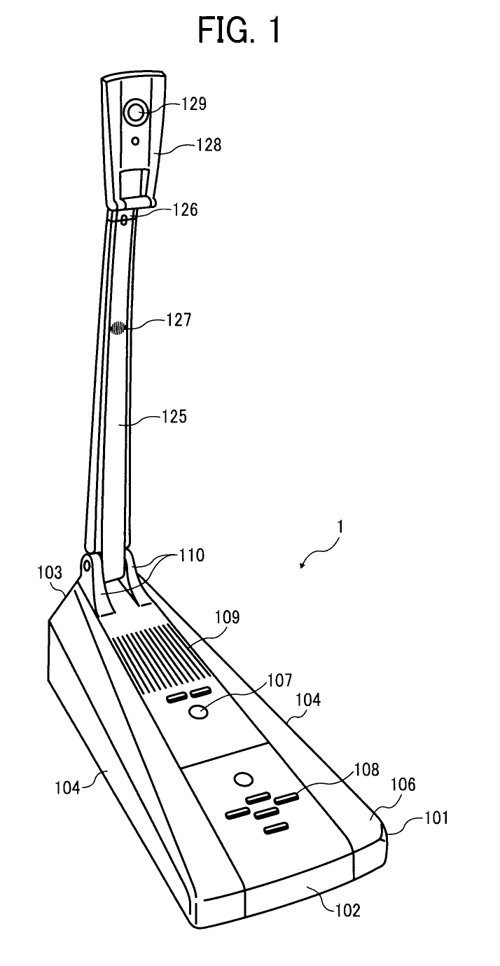

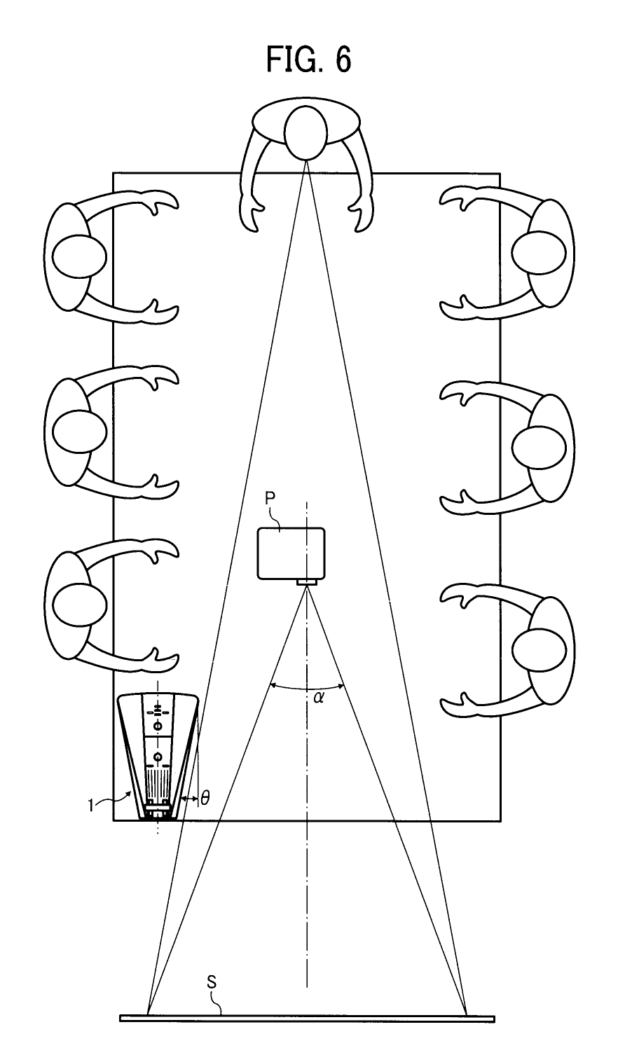

Referring now to FIGS. 1 to 6, a structure of a conference device 1 with a housing 101 is explained according to an example embodiment of the present invention. Referring to FIGS. 1 and 5, the conference device 1 includes the housing 101, a controller circuit, a speaker 123, a microphone 124, a camera 129, and an image output port 122.

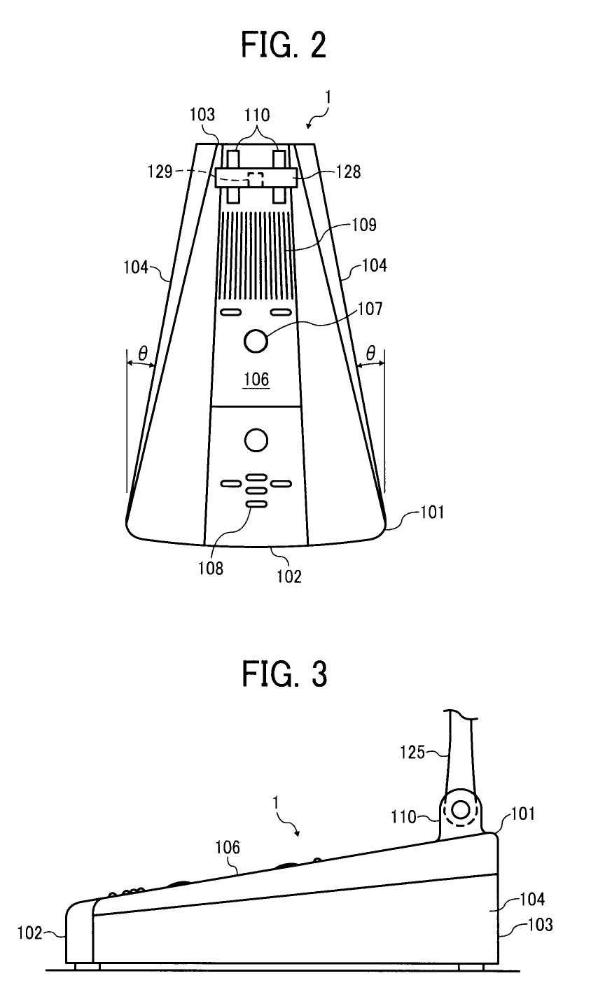

The housing 101 includes an upper housing portion and a lower housing portion. The upper housing portion of the housing 101 is made integral with the lower housing portion such as by screw. The housing 101 includes a top surface 106, a front surface 102, a back surface 103, a left surface, and a right surface. The left and right surfaces are collectively referred to as side walls 104. As illustrated in FIG. 2, when viewed from top, the width of the housing 101 is gradually made smaller from the front surface 102 toward the back surface 103 of the housing 101 such that the top surface 106 of the housing 101 has an isosceles trapezoid shape. As illustrated in FIG. 3, when viewed from side, the height of the housing 101 is gradually made higher from the front surface 102 toward the back surface 103 of the housing 101 such that the side surface, which could be either the let side wall 104 or the right side wall 104, of the housing 101 has a slanted shape that is slanted toward the front. Further, as illustrated in FIGS. 1 and 2, for each of the right and left sides, the edge section of the housing 101 between the top surface 106 and the side wall 104 is chamfered so as to form a chamfered side surface that extends from a corner of the upper housing portion at the front surface 102 to a corner of the upper housing portion at the back surface 103. The width of the chamfered side surface gradually increases from the front surface 102 to the back surface 103 of the housing 101.

When viewed from top as illustrated in FIG. 2, for each of the right and left sides, a sloped angle θ of the side wall 104 with respect to a straight line that is orthogonal to the front surface 102 or the back surface 103 has a value previously determined based on a horizontal view angle α of a projector P that is most likely to be connected to the image output port 122 (FIG. 5) of the conference device 1. More specifically, the sloped angle θ of the side wall 104 has a value that is equal to or less than the value of the horizontal view angle α of the projector P. For many cases, the horizontal view angle α of the projector P ranges between 20 and 40 degrees, depending on a specific machine or model type. In this example, the sloped angle θ of the side wall 104 ranges between 10 to 20 degrees.

As illustrated in FIG. 2, the housing 101 further includes, at the top surface 106 of the upper housing portion, openings for a power switch 107 and operation buttons 108. The top surface 106 further includes voice output holes 109 through which sounds from the speaker 123 (FIG. 5) are output. The top surface 106 is further provided with a bracket section 110, to which a camera section having the camera 129 and an arm is fixed.

The conference device 1 includes the controller circuit, which processes data such as voice data and/or image data to allow two-way communication of data through a network such as the Internet. As illustrated in FIG. 5, the controller circuit includes a central processing unit (CPU) 111, a read only memory (ROM) 112, a random access memory (RAM) 113, a solid state drive (SSD) 114 to which a flash memory 121 is connected, a medium drive 115, the operation button 108, the power switch 107, a network interface (I/F) 116, an imaging element interface (I/F) 117, a sound input/output (I/O) I/F 118, and an image output I/F 119, which are connected through a bus line 120 such as address bus or data bus to allow two-way communication. These devices of the controller circuit may be provided on a control board. In this example, the image data to be processed may be moving images or still images.

The CPU 111 controls entire operation of the conference device 1 according to a control program stored in a desired memory. For example, the CPU 111 generates instructions according to the control program to cause the conference device 1 to perform two-way communication of data through the network. The ROM 112 stores a program such as the initial program loader (IPL) to be executed by the CPU 111. The RAM 113 functions as a work area of the CPU 111.

The flash memory 121 stores therein various data such as image data and/or voice data, and various programs such as the control program to be executed by the CPU 111. The control program for the conference device may be written on a recording medium that is readable by a general-purpose computer in any format that is installable or executable by the general-purpose computer. Once the control program is written onto the recording medium, the recording medium may be distributed. Further, the control program may be stored in any desired memory other than the flash memory 121, such as the ROM 112.

The SSD 114 controls reading or writing of various data with respect to the flash memory 121 under control of the CPU 111.

The medium drive 115 controls reading or writing of various data with respect to a recording medium such as a recording medium M. The recording medium M may be freely attached to or detached from the conference device 1. In alternative to the recording medium M, any other nonvolatile memory that reads or writes data under control of the CPU 111 may be used such as Electrically Erasable and Programmable ROM (EEPROM).

The operation button 108 may be implemented as a key or a switch, which may be used by a user to select a counterpart conference device to start communication of image data and/or voice data. The operation button 108 may be electrically connected to the control board, or is mounted onto the control board.

The power switch 107 may be a button or a switch, which is used to switch on or off of the conference device 1. The power switch 107 may be electrically connected to the control board.

The network I/F 116 includes a connection port, such as the Ethernet port to allow input or output of data through the Internet.

The imaging element I/F 117 receives a signal output from the camera 129 as the camera captures an object, and converts the signal to image data for further processing.

The sound I/O I/F 118 converts a signal collected through the microphone 124 to voice data, or converts voice data received through the network to a signal for output through the speaker 123.

The image output I/F 119, which is connected to the image output port 122, converts image data received from the outside through the image output port 122 to an analog or digital image signal in a format that is applicable to the projector P and outputs the image signal to the projector P through the image output port 122. In one example, image data includes screen data to be projected onto the screen such as various information to be shown as a menu screen to start communication of image data and voice data with a counterpart conference device through the network, such as an address of the counterpart conference device, image quality adjustment, and output signal selection, preferably with an operation icon for selection by the user. Other examples of image data include, but not limited to, encoded image data received through the network, and image data captured by the camera 129 of the conference device 1.

The image output port 122 is mounted on the control board at a position such that is exposes from a back side of the back surface 103 of the conference device 1. Examples of image signal to be output to the image output port 122 includes analog RGB signal (VGA), component video signal, High-Definition Multimedia Interface (HDMI) signal, and Digital Video Interactive (DVI) signal.

The speaker 123, which may be implemented by a full-ranged speaker, is connected to the sound I/O I/F 118. The speaker 123 is disposed at a back side of the top surface 106 to allow sounds from the speaker 123 to be output through the sound output holes 109 formed on the top surface 106. The microphone 124, which may be a unidirectional microphone, is connected to the sound I/O I/F 118 and is disposed at about a midway of the arm.

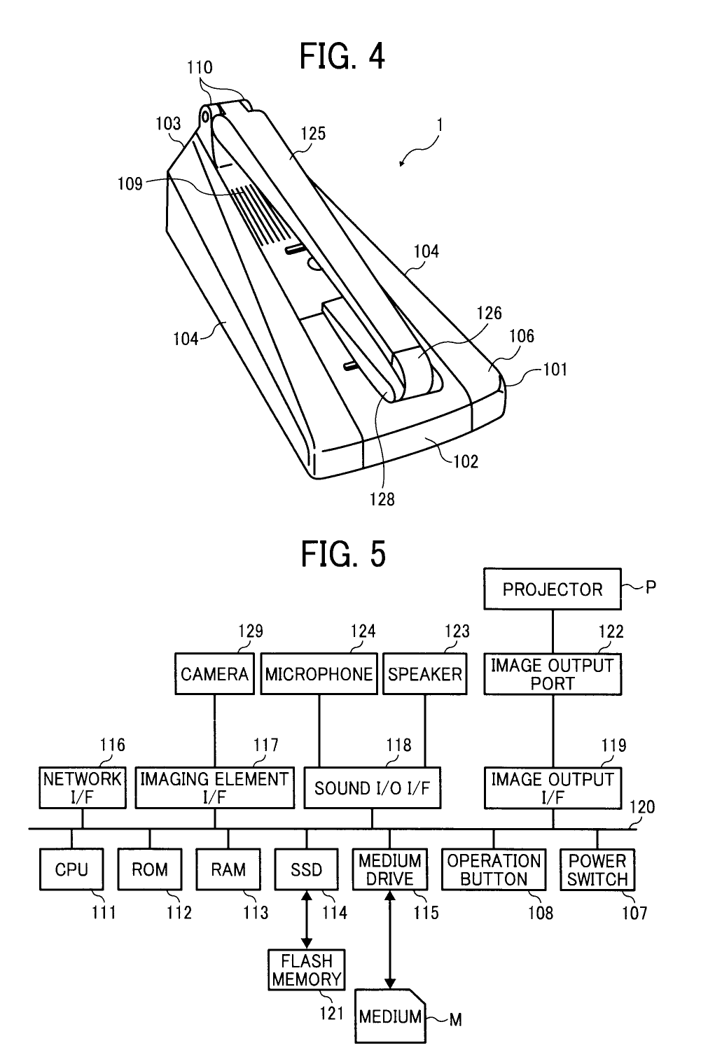

As illustrated in FIG. 1, the camera section includes the arm, a camera housing 128, and a body of the camera 129. The arm includes a first arm 125, which is connected to the bracket section 110 in a manner that is rotatable around the bracket section 110. The first arm 125 may change its position from the stand-up position shown in FIG. 1 to the folded position shown in FIG. 4. The arm further includes a second arm 126, which is connected to a tip of the first arm 125 in a manner that is rotatable around the first arm 125. The second arm 126 rotates around the first arm 125, while making the pan angle, in the right or left direction, which ranges between −180 degrees to +180 degrees. The pan angle of 0 degree is obtained when the second arm 126 faces toward the front as shown in FIG. 1. The arm is implemented as a hollow square-shaped tube, with its cross-sectional width being gradually smaller toward the camera housing 128. About at the midway of the first arm 125, a sound input hole 127 is formed. The microphone 124 (FIG. 5) is incorporated in the first arm 125 at the midway section of the first arm 125 where the sound input hole 127 is provided, such that the microphone 124 collects sounds such as the human voice through the sound input hole 127.

The camera housing 128, which has a hollow rectangular shape, is connected to the second arm 126 in a manner that is rotatable around the second arm 126, thus allowing the camera housing 128 to rotate downward from the stand-up position. The first arm 125, the second arm 126, and the camera housing 128 are each provided with a torque hinge to cause each of them movable. With this torque hinge, any one of the first arm 125, the second arm 126, and the camera housing 128 may stay at a specific position to make a specific rotation angle. Once force is applied to the torque hinge, the torque hinge causes any one of the first arm 125, the second arm 126, and the camera housing 128 to be rotatable.

The camera body 129, which may be referred to as the camera 129, is provided with a lens system including an aperture, and a single-focus wide-angle lens “a” having a short focal length. The components of the lens system are arranged such that the image of an object that passes the wide-angle lens “a” is focused. The camera 129 further includes an imaging element, which performs electro-photographic conversion on the object image to generate image data. The imaging element allows deep depth of field. The imaging element of the camera 129 is connected to the imaging element I/F 117. Further, the camera 129 is incorporated in the camera housing 128 at a specific position such that the wide-angle lens is exposed though a lens hole formed on the camera housing 128.

As illustrated in FIG. 4, the camera housing 128 is folded, while facing the first arm 125. Further, the first arm 125 is folded, while facing the top surface 106 of the upper housing portion. In this manner, the conference device 1 is made compact in the folded position such that it can be easily carried.

As illustrated in FIG. 1, the length of the arm is previously determined such that, when the first arm 125 and the camera housing 128 are both in the stand-up position, the center of the lens of the camera 129 would be positioned at eye level of a human. More specifically, the length of the arm is determined such that the distance between the center lens and the surface of a conference table where the conference device 1 is placed will be substantially the same as eye level of an adult having an average height.

Referring now to FIG. 6, an example layout of the conference device 1 and the projector P is explained.

In this example, the projector P is placed such that the distance between the screen S and the projector P has a value that ranges from 2 meters to 3 meters. Further, the conference table of this example is designed for use by 6 to 8 persons. The projector P having a horizontal view angle α of 40 degrees is placed at the table center, but little closer to the screen S. Further, the conference device 1 is placed between the projector P and the screen S, specifically, at a position outside the horizontal view angle α of the projector P. Further, it is preferable to place the conference device 1 such that a person who sits at a position facing the screen S via the table is not prevented from viewing the projected image projected on the screen S by the conference device 1. Referring to FIG. 6, such recommended set position of the conference device 1 can be either the right or left side of the table. Further, it is assumed that the conference device 1 has a size that can be placed at the recommended set position. By placing the conference device 1 at the recommended set position, the projection lights projected from the projector P toward the screen S would not be blocked by the conference device 1.

Once the conference device 1 is placed at the recommended set position, the conference device 1 is supplied with electrical power supply from the outside source. At this time, the network I/F 116 is connected to the Internet through a cable via connection ports, and the image output I/F 119 is connected to the projector P through a cable via the image output port 122. The camera housing 128 and the first arm 125 are each made in the stand-up position. After the power of the conference device 1 is turned on through selection of the power switch 107, the operation button 108 is selected to adjust various settings and select a counterpart conference device to start communication with the selected counterpart conference device through the Internet.

In operation, the conference device 1 performs the following operation according to instructions received from the CPU 111 based on the control program.

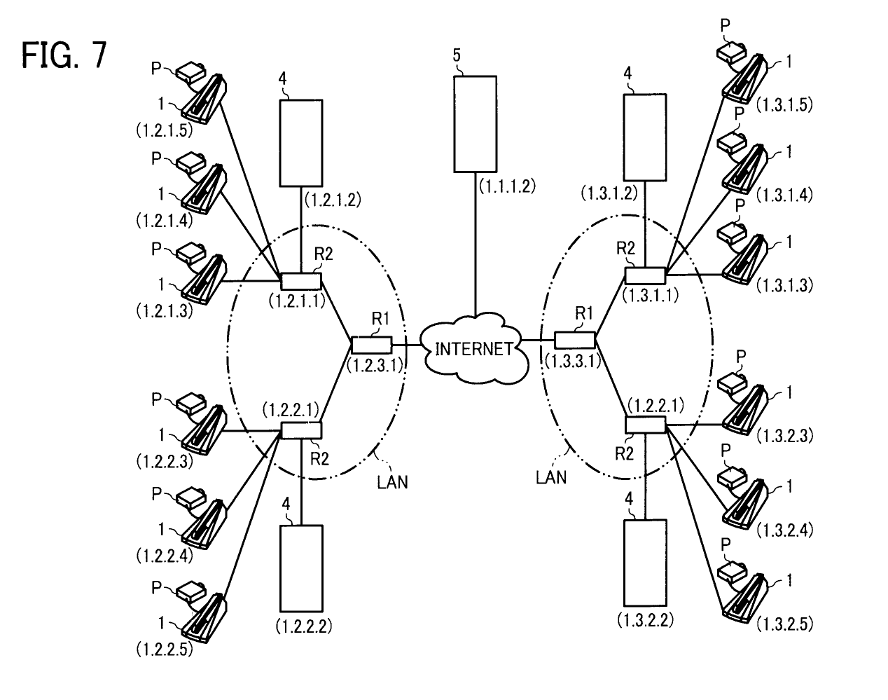

In this example, the conference device 1 is provided in a conference system of FIG. 7. The conference system of FIG. 7 includes a local area network (LAN) in which a router R1 connected to the Internet and a plurality of routers R2 each connected to the router R1 are provided. The conference system of FIG. 7 further includes a plurality of conference devices 1 each connected to the LAN through the router R2, a plurality of relay devices 4, and a communication management apparatus 5 connected to the Internet.

The conference device 1 displays a menu screen onto the projector P connected to the conference device 1 as the power is turned on. The menu screen includes various icons or characters to allow the user to adjust various functions or to start two-way communication. The user may input selections or instructions to the conference device 1 through the operation button 108 provided at the top surface 106 of the conference device 1. Alternatively, a remote controller may be provided to allow the user to remote control the conference device 1.

The conference device 1 obtains captured image data from the camera 129, and encodes the captured image data using a predetermined codec, for example, to output encoded image data based on high-resolution image data of 640 by 480 pixels, medium-resolution image data of 320 by 240 pixels, and low-resolution image data of 160 by 120 pixels. The encoded image data is decodable into a moving image, or an intermittent image such as a still image to be displayed for a predetermined time. In this example, the user can select to display image data either as moving image or intermittent image from the menu screen. Further, the conference device 1 is able to combine a plurality of images respectively received from a plurality of counterpart conference devices to output as a combined image, using the picture-in-picture function.

The relay device 4 is implemented by a computer, which performs various functions according to a predetermined control program. In this example, the relay device 4 monitors the quality of communication network, such as data transmission speed, and sets resolution of image data that is applicable to the monitored transmission speed. More specifically, the relay device 4 determines whether there is any time difference in receiving between image data and voice data while the conference devices communicate with each other, due to the status of communication network or processing conditions at the conference device 1. When the relay device 4 detects that there is time difference in receiving between the voice data and the image data, the relay device 4 selects an image resolution that is more suitable to the conference device 1 that may be causing such time difference, and sends information regarding the selected resolution to the conference device 1. More specifically, in this example, the image resolution is selected from high-resolution, medium-resolution, and low-resolution. In this manner, even when the quality of communication network is lowered, which may cause delay in data transmission or transmission error, image data such as a still image may be communicated without causing interruption.

In order to solve this problem caused by the time difference in receiving between image data and voice data, the relay device 4 may also change a frame rate. In such case, the relay device 4 may consider the balance between the frame rate and the image resolution to determine the best combination of the frame rate and the image resolution.

As described above, the relay device 4 periodically monitors the quality of communication network to manage transmission of voice data and image data, for example, by detecting the time difference and specifying the image resolution or the frame rate.

The communication management apparatus 5 may be implemented by a computer, which manages the conference devices 1 according to a control program. More specifically, the communication management apparatus 5 centrally manages the conference devices 1 and the relay devices 4 in the system, such as the current operation state of each conference device 1 indicating whether the conference device 1 is communicating, waiting, or not turned on, authentication of the conference device 1, sending a list of addresses of counterpart conference devices to the conference device 1, selecting the relay device 4, and charging each conference device 1 for having communication.

Now, operation of communicating with a counterpart conference device, performed by the conference device 1, is explained according to an example embodiment of the present invention.

In this example, it is assumed that the conference device 1 and an image output device such as the projector P are connected and turned on to have power supply. In the following examples, it is assumed that various data are to be displayed through the image output device connected to the conference device 1. Further, it is assumed that various input to the conference device 1 are made through the operation button 108 or the remote controller. For simplicity, it is assumed each conference device 1 is assigned with a specific IP address, which may be expressed as four digit numbers such as (1.1.1.2).

When the user instructs the conference device 1 to start communication with the counterpart conference device, the conference device 1 transmits a communication start signal to the communication management apparatus 5 through the communication network such as LAN or the Internet.

The communication management apparatus 5 determines whether the conference device 1, which sends the communication start signal, is an authorized device. When it is determined that the conference device 1 is authorized, the communication management apparatus 5 sends an address list, which lists a plurality of conference devices that are previously registered to the communication management apparatus 5 together with the current operation state of each of the conference device, for display through the conference device 1. This address list includes icons and characters to indicate identification information and operation state information of each of the counterpart conference devices. Further, the address list is periodically updated under control of the communication management apparatus 5.

Assuming that the user at the conference device 1 selects a counterpart conference device for two-way communication, the conference device 1 sends such selection information to the communication management apparatus 5. The communication management apparatus 5 selects one of the relay devices 4, which is most suitable for communication between the conference device 1 and the selected counterpart conference device. For example, the communication management apparatus 5 may select the relay device 4, which is located closely to the conference device 1. In case the relay device 4 that is closely located to the conference device 1 is in trouble, any other relay device 4 may be selected. For example, assuming that the conference device 1 has the IP address (1.2.1.5), the relay device 4 having the IP address (1.2.1.2) may be selected. In case the relay device having the IP address (1.2.1.2) is in trouble, the relay device 4 having the IP address (1.2.2.2) is selected.

After selection of the relay device 4, the communication management apparatus 5 sends a communication start request to the counterpart conference device 1 through the relay device 4. The counterpart conference device 1 causes an image output device, such as the projector P, to display a message indicating that the communication start request is received. Based on an instruction that accepts establishment of connection, communication between the conference device 1 and the counterpart conference device is started. For example, when the counterpart conference device 1 receives the communication start request, the counterpart conference device 1 may change the address list, which is being displayed, to reflect that the conference device 1 requests to start communication.

As described above, the relay device 4 periodically monitors the quality of communication network such as transmission speed. When the quality of communication network is lowered, the relay device 4 sets the image resolution to be lowered than the currently-set image resolution. Alternatively or additionally, the frame rate may be lowered.

In addition to allowing communication to start between the conference devices 1, the communication management apparatus 5 specifies each of the conference devices 1 having communication, counting a communication time period, etc. Such information may be used to determine a charge fee that is charged as usage of the conference system.

When the user instruction that ends communication is received through the operation button 108 or the remote controller, communication between the conference device 1 and the counterpart conference device 1 ends.

In this example, the conference device 1 has the housing 101. When viewed from top, for each of the right and left sides of the housing 101, the sloped angle θ of the side wall 104 with respect to a straight line that is orthogonal to the front surface 102 or the back surface 103 has a value that is equal to or less than half of the horizontal view angle α of the projector P to be connected to the image output port 122. With these sloped angles, when viewed from top, the width of the housing 101 is gradually made smaller from the front surface 102 toward the back surface 103 such that the top surface 106 of the housing 101 has an isosceles trapezoid shape. Accordingly, even when the conference device 1 is placed between the projector P and the screen S as illustrated in FIG. 6, the projected lights projected from the projector P toward the screen S is not blocked by the conference device 1.

In case of the background conference device having a housing with its front or back surface being extended in the horizontal direction, when the conference device is placed between the projector P and the screen S as illustrated in FIG. 6, the conference device 1 is most likely to block the projected lights path.

Further, since the housing 101 of the conference device 1 has the top surface 106 having an isosceles trapezoid shape, even when the conference device 1 is placed between the projector P and the screen S, the conference device 1 can be placed at the position that is close to the projected lights path, thus improving the shooting angle.

Further, when viewed from side, the height of the side surface of the housing 101 is gradually made higher from the front surface 102 toward the back surface 103. Since it is the human nature to instantly think that the lower part should be placed in front and the higher part should be placed away, a general user is most likely to place the conference device 1 as illustrated in FIG. 6. With this shape, the recommended orientation of the conference device 1 can be instantly known, thus allowing more smooth settings.

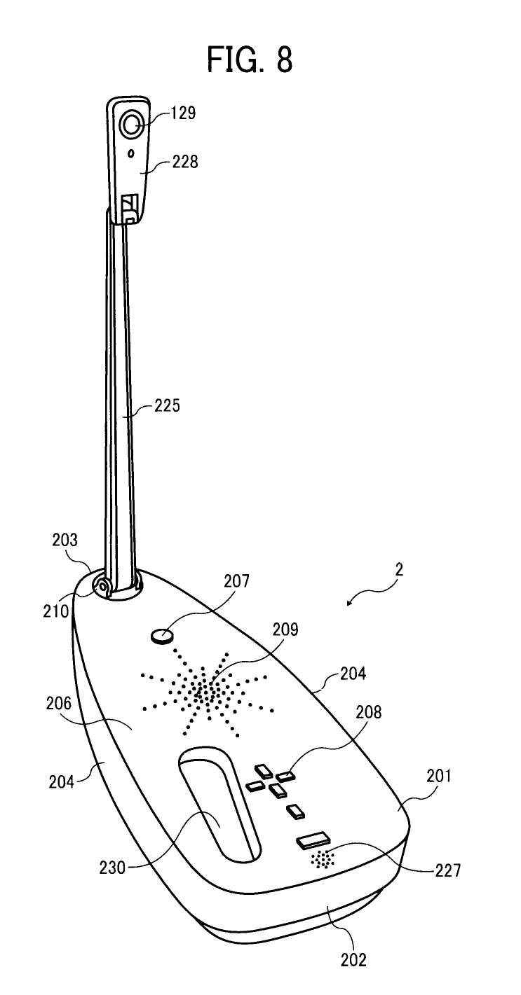

The conference device 1 of FIGS. 1 to 7 may have an outer appearance different from the outer appearance shown in FIGS. 1 to 7. In one example, as illustrated in FIGS. 8 to 11, a conference device 2 may be provided, which has a housing 201 that is made more circular than the housing 101 of FIG. 1.

Referring now to FIGS. 8 to 11, the conference device 2 with the housing 201 is explained according to an example embodiment of the present invention. The conference device 2 is substantially similar to the conference device 1 in hardware structure and system implementation, except for several differences mainly in appearance.

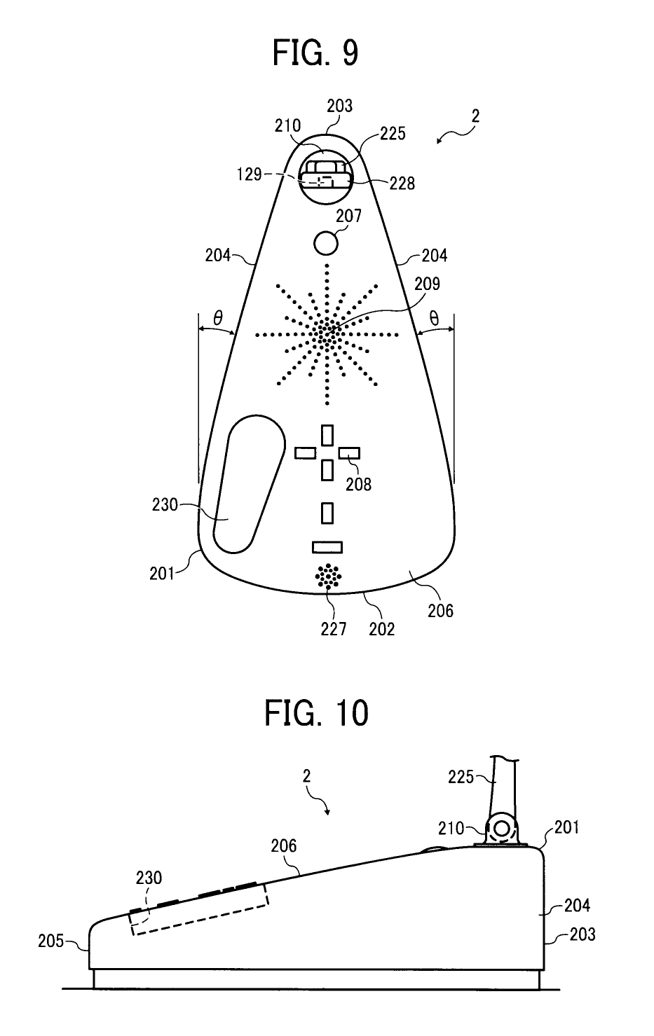

The housing 201 includes an upper housing portion and a lower housing portion. The upper housing portion of the housing 201 is made integral with the lower housing portion such as by screw. The housing 201 includes a top surface 206, a front surface 202, a back surface 203, a left surface, and a right surface. The left and right surfaces are collectively referred to as side walls 204. As illustrated in FIG. 9, when viewed from top, the width of the housing 201 is gradually made smaller from the front surface 201 toward the back surface 203 of the housing 201 such that the top surface 106 of the housing 201 has an isosceles triangle shape. As illustrated in FIG. 10, when viewed from side, the height of the housing 201 is gradually made higher from the front surface 202 toward the back surface 203 of the housing 201 such that the side surface, or the side wall 204, of the housing 201 has a slanted shape that is slanted toward the front.

When viewed from top as illustrated in FIG. 9, for each of the right and left sides, a sloped angle θ of the side wall 204 with respect to a straight line that is orthogonal to the front surface 202 or the back surface 203 has a value that is equal to or less than half of the value of the horizontal view angle α of the projector P to be connected to the image output port 122.

As illustrated in FIG. 9, the housing 201 further includes, at the top surface 206 of the upper housing portion, openings for a power switch 207 and operation buttons 208. The top surface 206 further includes voice output holes 209 through which sounds from the speaker 123 are output. The top surface 206 is further provided with a hole near the back surface 203, through which a bracket section 210 is exposed. To the bracket section 210, a camera section having the camera 129, a camera housing 228, and an arm 225 is fixed. Still referring to FIG. 9, at the left side of the front surface 202, a concave section 230 is provided to accommodate the camera housing 228 therein when the camera housing 228 is in the folded position. The top surface 206 further includes sound input holes 227 at center portions toward the front surface 202.

The bracket section 210 is provided with a pair of support sections each having an angle structure. The bracket section 210 is fixed to a fixer that is incorporated in the housing 201 in a manner that is rotatable around the fixer, while making the pan angle, in the right or left direction, which ranges between −180 degrees to 180 degrees.

For the conference device 2, the microphone 124 that is the same as the microphone 124 of the conference device 1 is used, except for its location in the housing 201. The microphone 124, which may be a unidirectional microphone, is connected to the sound I/O I/F 118 and is disposed at a back side of the top surface 206 where the voice input holes 227 are provided. The microphone 124 collects sounds, which are input through the voice input holes 227.

The camera section includes the arm 225, the camera housing 228, and the body of the camera 129. The arm 225 is connected to the bracket section 210 in a manner that can be moved downward from the stand-up position shown in FIG. 8. The arm 225 is implemented as a hollow square-shaped tube, with its cross-sectional width being gradually smaller toward the camera housing 228. The camera housing 228, which has a hollow rectangular shape, is connected to the arm 225 in a manner that is rotatable around the arm 225, thus allowing the camera housing 228 to rotate downward from the stand-up position.

The bracket section 210, the arm 225, and the camera housing 228 are each provided with a torque hinge to cause each of them movable. With this torque hinge, any one of the bracket section 210, the arm 225, and the camera housing 228 may stay at a specific position to make a specific rotation angle. Once force is applied to the torque hinge, the torque hinge causes any one of the bracket section 210, the arm 225, and the camera housing 228 to be rotatable. The camera 129 is the same as the camera 129 of the conference device 1.

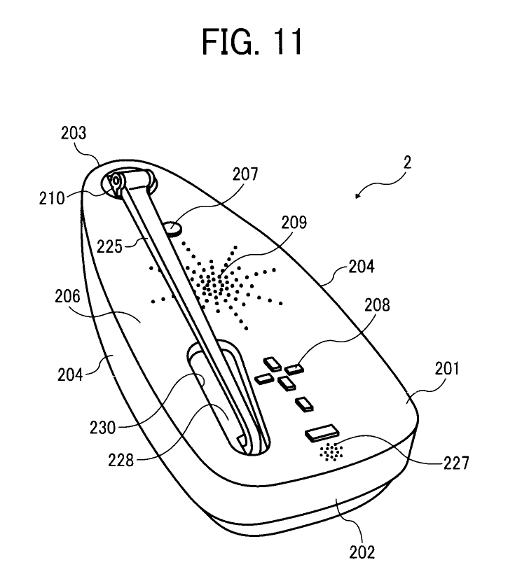

As illustrated in FIG. 11, the camera housing 228 is folded, while facing the arm 225. The camera housing 228 is folded such that it fits in the concave section 230. In this manner, the conference device 2 is made compact in the folded position such that it can be easily carried. Further, the center lens of the camera 129 of the conference device 2 is previously arranged such that, as described above for the conference device 1, the center lens of the camera 129 is placed at eye level when the arm 225 and the camera housing 228 are both in the stand-up position.

As described above, the conference device 2 has the housing 201. When viewed from top, for each of the right and left sides of the housing 201, the sloped angle θ of the side wall 204 with respect to a straight line that is orthogonal to the front surface 202 or the back surface 203 has a value that is equal to or less than half of the horizontal view angle α of the projector P to be connected to the image output port 122. With these sloped angles, when viewed from top, the width of the housing 201 is gradually made smaller from the front surface 202 toward the back surface 203 such that the top surface 206 of the housing 201 has an isosceles triangle shape. Accordingly, even when the conference device 2 is placed between the projector P and the screen S as illustrated in FIG. 6, the projected lights projected from the projector P toward the screen S is not blocked by the conference device 2.

Further, since the housing 201 of the conference device 2 has the top surface 206 having isosceles triangle shape, even when the conference device 2 is placed between the projector P and the screen S, the conference device 2 can be placed at the position that is close to the projected lights path, thus improving the shooting angle.

Further, when viewed from side, the height of the side surface of the housing 201 is gradually made higher from the front surface 202 toward the back surface 203. Since it is the human nature to instantly think that the lower part should be placed in front and the higher part should be placed away, a general user is most likely to place the conference device 2 as illustrated in FIG. 6. With this shape, the recommended orientation of the conference device 2 can be instantly known, thus allowing more smooth settings.

Further, as illustrated in FIG. 11, the housing 201 is provided with the concave section 230 in which the camera housing 228 can be accommodated in the folded position. In the folded position, the conference device 2 can be made more compact such that it can be easily carried.

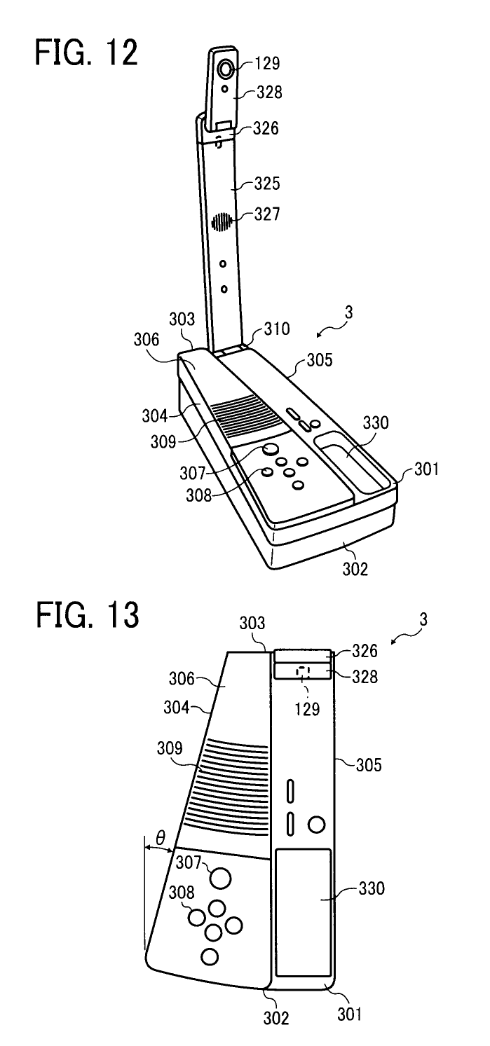

In any one of the conference device 1 and the conference device 2, when viewed from top, for each of the right and left sides, the side wall is slanted with respect to the straight line that is orthogonal to the front surface or the back surface of the housing. Alternatively, only one side wall may be slanted as in the case of a conference device 3 illustrated in FIGS. 12 to FIG. 16. The conference device 3 has a side wall 304 that is slanted, and a side wall 305 that is not slanted. The conference device 3 is substantially similar to the conference device 1 in hardware structure and system implementation, except for several differences mainly in appearance.

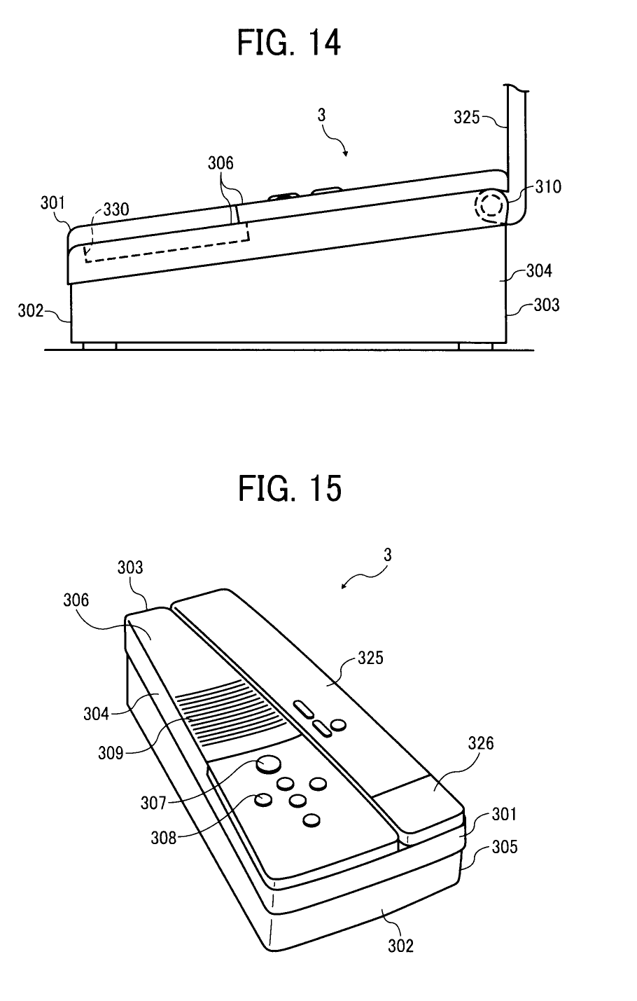

The housing 301 includes an upper housing portion and a lower housing portion. The upper housing portion of the housing 301 is made integral with the lower housing portion such as by screw. The housing 301 includes a top surface 306, a front surface 302, a back surface 303, a left surface such as a side wall 304, and a right surface such as a side wall 305. As illustrated in FIG. 13, when viewed from top, a sloped angle θ of the left side wall 304 with respect to a straight line that is orthogonal to the fronts surface 302 or the back surface 303 has a value that is equal to or less than half of the value of the horizontal view angle α of the projector P to be connected to the image output port 122. The right side wall 305 is formed so as to extend in the direction that is substantially orthogonal to the front surface 302 or back surface 303. Further, when viewed from top, the width of the housing 301 is made gradually smaller from the front surface 302 to the back surface 303. As illustrated in FIG. 14, when viewed from side, the height of the housing 301 is gradually made higher from the front surface 302 to the back surface 303 of the housing 301 such that the side surface of the housing 301 has a slanted shape that is slanted toward the front.

As illustrated in FIG. 12, in this example, the top surface 306 of the upper holder portion is classified into a right side portion provided at the side of the right side wall 305, and a left side portion provided at the side of the left side wall 304, which are different in level. The right side portion of the top surface 306 is positioned lower than the left side portion of the top surface 306. The right side portion of the top surface 306 is provided with a concave section 330 toward the front surface 302, in which a camera housing 328 is accommodated in the folded position. The right side portion of the top surface 306 is further provided with a bracket section 310 to allow a camera section to be connected to the top surface 306 near the back surface 303. The left side portion of the top surface 306 is provided with sound output holes 309 in the middle of the left side portion. The left side portion of the top surface 306 further includes openings near the front surface 302, from which a power switch 307 and operation buttons 308 are exposed.

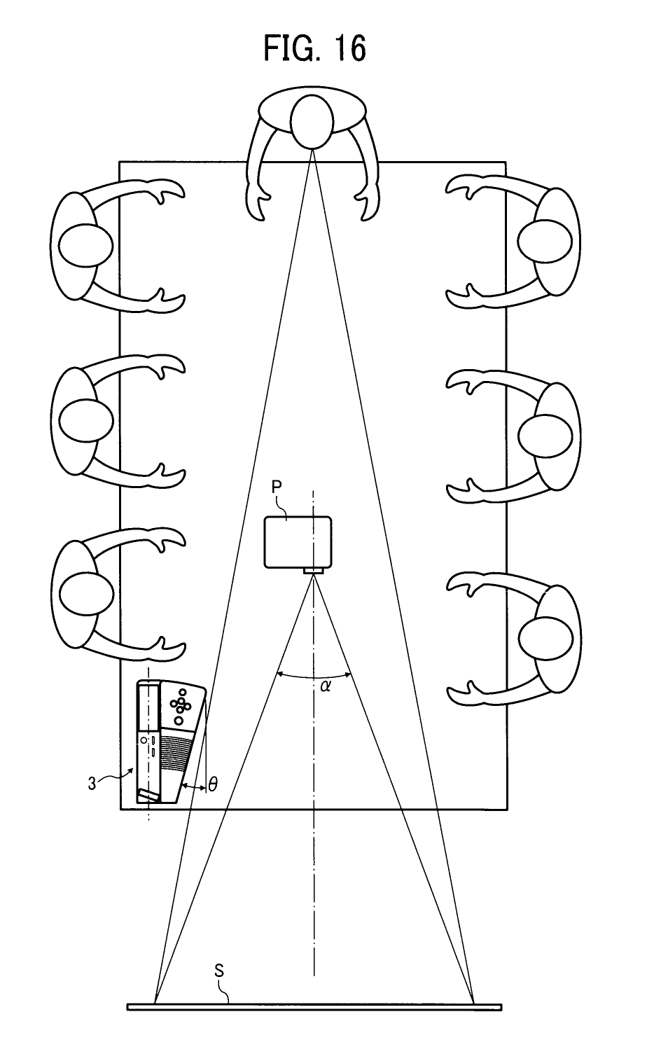

The camera 129 is substantially similar to the camera 129 of the conference device 1. As illustrated in FIG. 15, the camera housing 328, which is supported by a second arm 326 in a manner that is rotatable around the second arm 326 in upward or downward direction, may be folded, while facing the first arm 325 on which the sound input holes 327 are provided. The first arm 325 is folded such that the camera housing 328 is accommodated in the concave section 330. Thus, in the folded position, the conference device 3 can be made compact such that it can be easily carried.

Referring now to FIG. 16, an example layout of the conference device 3 and the projector P is explained. In this example, various conditions such as the distance between the screen S and the projector P and the horizontal view angle α of the projector P are the same as the conditions described above referring to FIG. 6.

In this example, the conference device 3 is placed at the recommended set position at the left side of the screen S in a manner such that the edge of the longer side of the table and the right side wall 305 of the conference device 3 are made in line, and that the edge of the shorter side of the table and the back surface 303 of the conference device 3 is made in line.

In addition to the advantages described above for the conference device 1 and the conference device 2, the conference device 3 is provided with the housing 301 having two side surfaces that interact at a right angle. With this structure, the conference device 3 fits with the rectangular shape of the table, when the conference device 3 is positioned with the right orientation at the recommended set position. With this shape, the recommended orientation as well as the recommend set position of the conference device 3 can be instantly known, thus allowing more smooth settings.

In any one of the above-described examples, it is assumed that the conference device is used together with the projector P as illustrated in FIGS. 6 and 16 in case more than one participant is present at one site. Alternatively, any desired image output device may be used in replace of the projector P.

Further, any one of the above-described housings may be used for any desired conference device, which is capable of communicating with a counterpart conference device. Further, any one of the above-described conference devices may be used in any desired communication system other than the system illustrated in FIG. 7. For example, if the control program that allows two-way communication with the counterpart conference device directly is installed, the communication management apparatus and/or the relay device may not be provided.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

For example, the conference device may communicate with the image output device such as the projector P through a wireless network such that a cable may not be necessarily connected to the image output port.

Further, the above-described example conference device uses internal devices such as the microphone 124 and the speaker 123 to carry out communication. Alternatively, any external device such as an external microphone or an external speaker may be connected to the conference device for use.

Further, the conference device 3 of FIG. 12 may be designed to have the outer appearance different from the one shown in FIG. 12. For example, the right side wall 305 may be caused to be slanted and the left side wall 304 to extend in the direction orthogonal to the front surface 302 or the back surface 303. In such case, the recommended set position would be changed from the left side to the right side in FIG. 16. Further, the arrangement of the components of the top surface 306 may be changed such that the right portion and the left portion of the top surface 306 may be reversed.

In one example, the present invention may reside in: a housing used for a conference device provided with an image output port to be connected to an image output device, and transmits or receives image data and voice data to or from a counterpart conference device through a communication network. The housing is formed such that, when viewed from top, the width of a top surface of the housing is made gradually smaller from a front surface to a back surface of the housing.

In one example, the housing further includes a side surface. The height of the side surface is made gradually higher from the front surface to the back surface of the housing to cause the side surface to have a slanted shape that is slanted toward the front.

In one example, the side surface forms a slanted angle with respect to a straight line that is orthogonal to the front surface or the back surface of the housing.

In one example, the slanted angle has a value that is equal to or less than half of a value of a horizontal view angle of the image output device.

In one example, the present invention may reside in a conference device including any one of the above-described housing. The conference device may further includes a controller circuit that controls transmission of image data and voice data, the image output port that is electrically connected to the controller circuit, a speaker that is electrically connected to the controller circuit to output sounds, a camera that is electrically connected to the controller circuit to capture an image, and a microphone that is electrically connected to the controller circuit to capture sounds.

As described above, a housing designed for a conference device that may be used together with an image output device that displays an image onto an object such as a screen. The housing includes a top surface, a front surface, and a back surface. The width of the top surface of the housing is made gradually smaller from the front surface to the back surface. With this structure, even when the conference device is placed between the image output device and the object, the projected lights projected from the image output device toward the object are not blocked by the conference device.

What is claimed is:

1. A housing for a conference device to receive image data from a network and to output processed image data to an image output device to cause the image output device to project an image based on the processed image data to an object, the housing including:
a top surface;
a front side surface; and
a back side surface provided opposite of the front side surface, wherein a cross-sectional width of the housing is gradually made smaller from the front side surface to the back side surface so as to make the top surface to have a trapezoid like shape or a triangle like shape.

2. The housing of claim 1, further comprising:
a side surface orthogonal to the front side surface or the back side surface, wherein a height of the side surface is gradually made larger from the front side surface to the back side surface so as to cause the side surface to be slanted toward the front side surface.

3. The housing of claim 2, wherein:
the side surface includes a first side surface and a second side surface that are opposed with each other, and
at least one of the first side surface and the second side surface forms a slanted angle with respect to a straight line that is orthogonal to the front side surface or the back side surface, the slanted angle having a value determined based on a horizontal view angle of the image output device.

4. The housing of claim 3, wherein
the value of the slanted angle is equal to or less than a half of the horizontal view angle of the image output device.

5. The housing of claim 4, wherein
the at least one of the first side surface and the second side surface that forms the slanted surface is the first side surface, and
the second side surface extends in a direction that is substantially orthogonal to the front side surface or the back side surface.

6. The housing of claim 4, further comprising:
an opening through which an image output port to be connected to the image output device is exposed.

7. The housing of claim 4, wherein the top surface includes:
a bracket section provided at a portion near the back side surface to allow a camera section having an image capturing device incorporated therein to be fixed to the housing in a manner that is rotatable with respect to the top surface; and
a concave section to accommodate at least a portion of the camera section therein when the camera section is in the position making a rotation angle with respect to the top surface to be nearly zero.

8. A conference device, comprising:
a housing including a top surface, a front side surface, and a back side surface provided opposite of the front side surface, wherein a cross-sectional width of the housing is gradually made smaller from the front side surface to the back side surface so as to make the top surface to have a trapezoid like shape or a triangle like shape;
a camera section fixed to the housing so as to be movable with respect to the top surface of the housing;
a controller circuit incorporated in the housing and configured to receive image data from a network and to output processed image data to an image output device to cause the image output device to project an image based on the processed image data to an object; and
an image capturing device incorporated in the camera section so as to be electrically connected to the controller circuit in the housing.

9. The conference device of claim 8, wherein the housing further includes:
a side surface orthogonal to the front side surface or the back side surface, wherein a height of the side surface is gradually made larger from the front side surface to the back side surface so as to cause the side surface to be slanted toward the front side surface.

10. The conference device of claim 9, wherein:
the side surface of the housing includes a first side surface and a second side surface that are opposed with each other, and
at least one of the first side surface and the second side surface forms a slanted angle with respect to a straight line that is orthogonal to the front side surface or the back side surface, the slanted angle having a value determined based on a horizontal view angle of the image output device.

11. The conference device of claim 10, wherein
the value of the slanted angle is equal to or less than a half of the horizontal view angle of the image output device.

12. The conference device of claim 11, wherein
the at least one of the first side surface and the second side surface of the housing, which forms the slanted surface is the first side surface, and
the second side surface of the housing extends in a direction that is substantially orthogonal to the front side surface or the back side surface.

13. The conference device of claim 8, further comprising:
an image output port electrically connected to the controller circuit and to be connected to the image output device.

14. The conference device of claim 13, further comprising:
a speaker electrically connected to the controller circuit and to output sounds processed by the controller circuit through openings provided in the housing; and
a microphone electrically connected to the controller circuit and to input sounds collected through openings provided in the housing for further processing.
